(19) United States
(12) Patent Application Publication
(10) Pub. No.: US 2019/0068025 A1
(43) Pub. Date: Feb. 28, 2019

(54) Magnetically-Driven Actuator Assembly

(71) Applicant: GM GLOBAL TECHNOLOGY OPERATIONS LLC, Detroit, MI (US)

(72) Inventors: David R. Petrucci, Warren, MI (US); David T. Renke, Macomb, MI (US); Dorel M. Sala, Troy, MI (US)

(21) Appl. No.: 15/690,993

(22) Filed: Aug. 30, 2017

(51) Int. Cl. H02K 7/14; H02K 11/33; B60S 1/08; B60S 1/56

(52) U.S. Cl. CPC H02K 7/14; B60S 1/566; B60S 1/0818; H02K 11/33

(57) ABSTRACT

An actuator assembly includes a driver element, a driven element, and a panel disposed between the driver element and the driven element. The driver element has a first magnetic field generator configured to generate a rotating magnetic field. The driven element has a second magnetic field generator disposed thereon. The panel physically separating the driver element and the driven element, such that in response to the rotating magnetic field, the driven element is rotated relative to the panel.

### TECHNICAL FIELD

The present disclosure relates to actuator assemblies, and more particularly to actuator assemblies for use in automotive vehicles.

### INTRODUCTION

In conventional automotive vehicles, a variety of sensors may be provided. Some such sensors, such as a rear view camera or backup camera, are provided with lenses through which signals are received. Likewise, vehicles having autonomous features such as adaptive cruise control or higher levels of autonomy may be provided with optical cameras as well as additional sensors such as LiDAR having lenses. Such lenses may become dirty, obscuring images or other signals received by the associated sensors. As such, there is a need to keep such lenses clean.

### SUMMARY

An actuator assembly according to the present disclosure includes a driver element, a driven element, and a panel disposed between the driver element and the driven element. The driver element has a first magnetic field generator configured to generate a rotating magnetic field. The driven element has a second magnetic field generator disposed thereon. The panel physically separating the driver element and the driven element, such that in response to the rotating magnetic field, the driven element is rotated relative to the panel.

In an exemplary embodiment the driven element is provided with a wiper member fixedly coupled to the driven element for co-rotation relative to the panel. The driven element may have a body, with the wiper member being disposed between the body and the panel. The body may have a periphery with at least one aperture being provided around the periphery. Such embodiments may additionally include a sensor having a lens, with the lens being in register with the panel, where the driven element has a first position and a second position, and where in the first position the aperture is aligned with the lens to uncover the lens and in the second position the body covers the lens. Such embodiments may additionally include a controller configured to, in response to a first operating condition being satisfied, control the driver element to move the driven element to the first position, and to, in response to a second operating condition being satisfied, control the driver element to move the driven element to the second position. Such embodiments may additionally include an automotive vehicle, where the first operating condition includes a drive cycle being initiated and the second operating condition includes a drive cycle being terminated.

In an exemplary embodiment, the actuator assembly further includes a housing mounted to the panel, with the driven element being rotatably retained by the housing.

In an exemplary embodiment, the driver element includes an electric motor having an output shaft, with the output shaft being coupled to a driver body provided with a plurality of permanent magnets. The driven element may include a driven body provided with a second plurality of permanent magnets.

In an exemplary embodiment, the driver element includes a plurality of electromagnets arranged circumferentially about the driver element and a controller configured to sequentially energize respective electromagnets of the plurality of electromagnets to generate the rotating magnetic field.

An automotive vehicle according to the present disclosure includes a panel having a first side and a second side. A driver element is disposed proximate the first side. The driver element has a first magnetic field generator. A driven element is disposed proximate the second side. The driven element has a second magnetic field generator disposed thereon. The driven element is physically separated from the driver element by the panel. The vehicle additionally includes a controller configured to control the driver element to generate a rotating magnet field. In response to the rotating magnetic field, the driven element is rotated relative to the panel.

In an exemplary embodiment, the driven element is provided with a wiper member. The wiper member is fixedly coupled to the driven element for co-rotation relative to the panel. In such embodiments, the driven element may have a body, with the wiper member being disposed between the body and the panel. The body may have a periphery, with at least one aperture being provided around the periphery. Such embodiments may additionally include a sensor with a lens in register with the panel, where the driven element has a first position aligned with the lens to uncover the lens and a second position in which the body covers the lens. The controller is configured to, in response to a first operating condition being satisfied, control the driver element to move the driven element to the first position, and, in response to a second operating condition being satisfied, control the driver element to move the driven element to the second position. The first operating condition may include a drive cycle being initiated and the second operating condition may include a drive cycle being terminated.

In an exemplary embodiment, the driver element includes an electric motor having an output shaft, with the output shaft being coupled to a driver body provided with a plurality of permanent magnets. The driven element may include a driven body provided with a second plurality of permanent magnets.

A method of controlling a vehicle according to the present disclosure includes providing the vehicle with a panel having a first side and a second side, a driver element with a first magnetic field generator disposed proximate the first side, a driven element with a second magnetic field generator disposed proximate the second side, and a controller configured to control the driver element. The driven element is physically separated from the driver element by the panel. The driven element has distinct first and second positions with respect to the panel. The method additionally includes, in response to a first operating condition, controlling the driver element, via the controller, to generate a rotating magnet field to move the driven element to the first position. The method further includes, in response to a second operating condition, controlling the driver element, via the controller, to generate a rotating magnet field to move the driven element to the second position.

Embodiments according to the present disclosure provide a number of advantages. For example, the present disclosure provides an actuator assembly for indirectly driving a wiper or other similar rotatable component without necessitating a hole through an intervening panel. Moreover, actuator assemblies according to the present disclosure may provide compact wiper assemblies relative to known solutions.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic view of an actuator assembly according to an embodiment of the present disclosure;

FIG. 2 is a plan view of a driver element of an actuator assembly according to an embodiment of the present disclosure;

FIG. 3 is a cross-sectional view of the driver element illustrated in FIG. 2;

FIG. 4 is an illustration of a driven element of an actuator assembly according to an embodiment of the present disclosure;

FIG. 5 is a flowchart representation of a method of controlling an actuator assembly according to an embodiment of the present disclosure;

FIG. 6 is an illustration of a driver element of an actuator assembly according to an embodiment of the present disclosure; and

FIG. 7 is a schematic view of an actuator assembly according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desirable for particular applications or implementations.

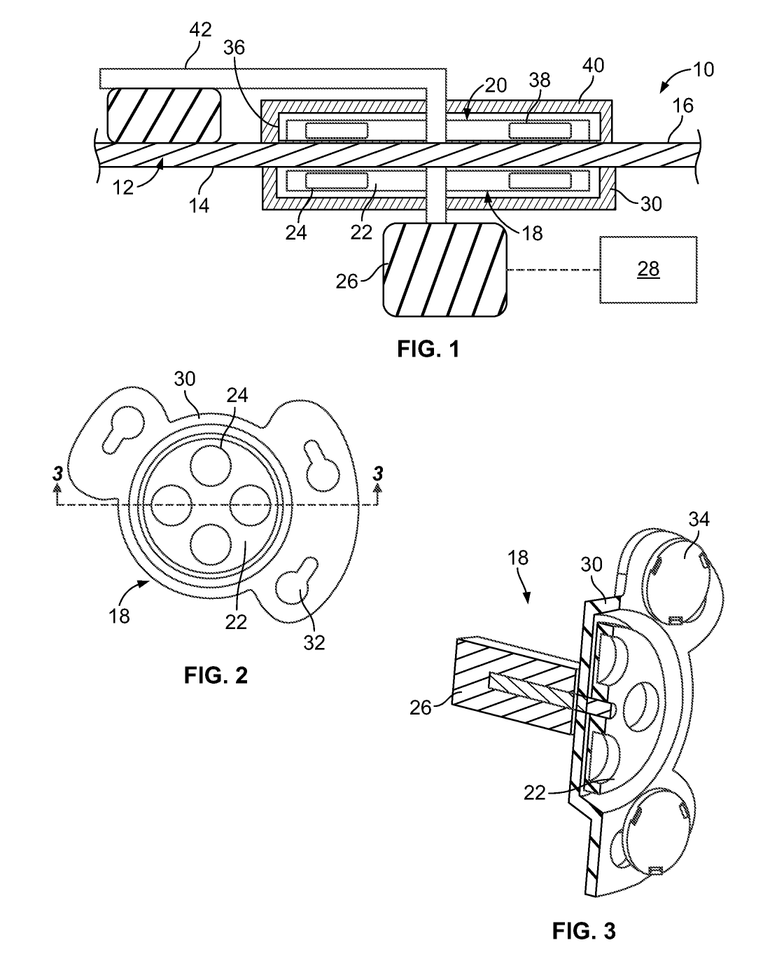

Referring now to FIG. 1, an exemplary actuator assembly 10 according to the present disclosure is illustrated.

A panel 12 has a first surface 14 and a second surface 16. In an exemplary embodiment, the panel 12 includes a pane of window glass, the first surface 14 is an interior surface of the pane of window glass, and the second surface 16 is an exterior surface of the pane of window glass.

The actuator assembly 10 includes a driver element 18 disposed on the first surface 14 and a driven element 20 disposed on the second surface 16. The driver element 18 and driven element 20 are thereby physically separated from one another by the panel 12.

The driver element 18, shown in further detail in FIGS. 2 and 3, includes a first magnetic field generator 22. The first magnetic field generator 22 is configured to generate a rotating magnetic field. In the illustrative embodiment of FIG. 1, the first magnetic field generator 22 includes a generally disk-shaped body provided with a first plurality of permanent magnets 24 coupled to an output shaft of a motor 26. However, as will be discussed in further detail below, other arrangements for the first magnetic field generator 22 are considered within the scope of the present disclosure.

The first magnetic field generator 22 is under control of a controller 28. While depicted as a single unit, the controller 28 may include one or more additional controllers collectively referred to as a “controller.” The controller 28 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The first magnetic field generator 22 is rotatably retained by a first housing 30 which is secured to the first surface 14. In the exemplary embodiment of FIGS. 2 and 3, the first housing 30 is provided with a plurality of retention holes 32 for coupling to a corresponding plurality of retention clips 34, which may in turn be secured to the first surface 14 via an adhesive or other appropriate means. However, in other embodiments the housing first 30 may be secured to the first surface 14 by other conventional means.

The controller 28 may control the first magnetic field generator 22 to selectively generate a rotating magnetic field. In the embodiment illustrated in FIGS. 1 through 3, the controller 28 may control the motor 26 to rotate the body and, in turn, to rotate the first plurality of permanent magnets 24. However, in other embodiments having other arrangements for the first magnetic field generator 22, the controller 28 may control the magnetic field generator 22 to generate a rotating magnetic field by other means as will be discussed in further detail below.

The driven element 20 includes a second magnetic field generator 36. The second magnetic field generator 36 is configured to rotate in response to the rotating magnetic field produced by the first magnetic field generator 22. In the illustrative embodiment of FIG. 1, the second magnetic field generator 36 includes a generally disk-shaped body provided with a second plurality of permanent magnets 38. However, as will be discussed in further detail below, other arrangements for the second magnetic field generator 36 are considered within the scope of the present disclosure.

The second magnetic field generator 36 is rotatably retained by a second housing 40 which is secured to the second surface 16.

The driven element 20 is coupled to a wiper member 42. The wiper member 42 is configured to sweep across the second surface 16 to remove liquid or debris in response to rotational motion of the driven element 20. However, in other embodiments, the driven element 20 may be coupled to other functional members to fulfill other tasks, as will be discussed in further detail below.

In a variation on the embodiment illustrated in FIG. 1, a gearing assembly may be provided between the driven element 20 and the wiper member 42. The gearing assembly may have a gear ratio selected to multiply angular displacement, such that a relatively small rotation of the driven element 20 may result in a larger rotation of the wiper member 42 or vice versa.

In another variation of the above, a different motive source, such as a solenoid, is provided in stead of the motor 26 to pivot or rotate the body of the first magnetic field generator 22 and, in turn, to rotate the first plurality of permanent magnets 24.

In yet another variation of the above, a piezo crystal may be provided in the wiper member 42. In such a variation, inductive coils may be provided with the driver element 18 and driven element 20 to selectively energize the piezo crystal and thereby heat the wiper member 42.

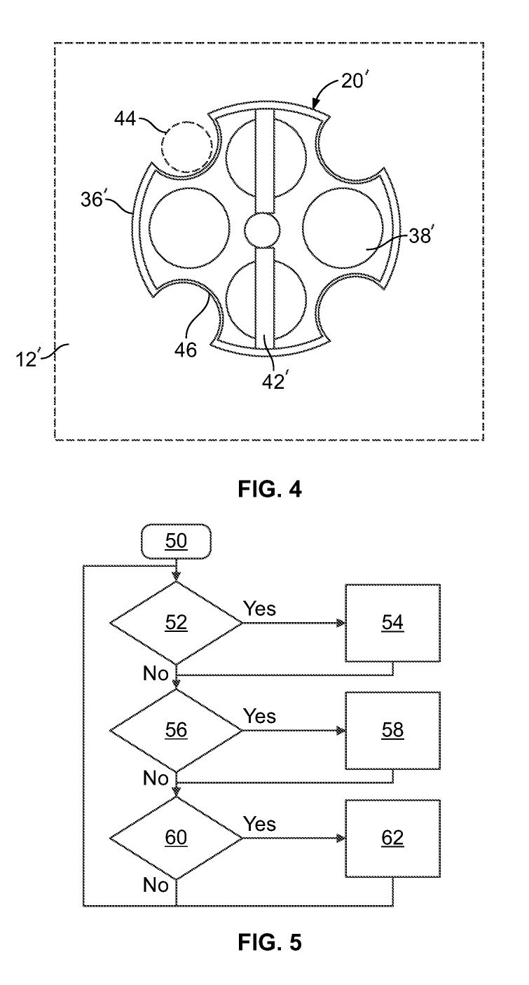

Referring now to FIG. 4, an alternative embodiment of a driven element 20′ is illustrated. The driven element 20′ is illustrated schematically as seen from below, i.e. through a panel 12′. The driven element 20′ includes a second magnetic field generator 36′ with a generally disk-shaped body provided with a plurality of permanent magnets 38′. One or more wiper members 42′ are disposed between the body of the second magnetic field generator 36′ and the panel 12′. In such embodiments, the portion of the panel 12′ which is wiped of fluid or debris is approximately the same dimension as the second magnetic field generator 36′. The driven element 20′ may be used in conjunction with a driver element similar to that illustrated in FIG. 1 or in the other embodiments discussed below.

Advantageously, a driven element 20′ may provide a low-profile cleaning apparatus for a sensor lens. In the embodiment of FIG. 4, a sensor is provided with a lens area 44 which is generally contiguous with or in register with the panel 12′. The lens area 44 is at least partially within the region wiped by the wiper members 42′, e.g. the distance from the lens area 44 to the center of rotation of the second magnetic field generator 36′ is less than the radius of the second magnetic field generator 36. The body of the second magnetic field generator 36′ is provided with one or more apertures 46. The aperture or apertures 46 are sized and positioned such that in a first position, the lens area 44 is in register with an aperture 46 as illustrated in FIG. 4, thereby enabling the sensor to detect a region external the vehicle. In a second position, the lens area 44 is covered by the body of the second magnetic field generator 36, thereby protecting the lens area 44 from debris or damage.

Referring now to FIG. 5, a method of controlling an actuator according to the present disclosure is illustrated in flowchart form. In an exemplary embodiment, the actuator includes a driven element configured generally similar to the driven element 20′, having a first position for enabling a sensor to detect a region external the vehicle, a second position for covering the sensor lens, and a wiper member for cleaning the sensor lens. The method may be performed, for example, by means of an algorithm programmed into the controller 28. The algorithm begins at block 50.

A determination is made of whether a sensing condition is satisfied, as illustrated at operation 52. The sensing condition may include, for example, a drive cycle being initiated, or a sensing request from a controller during a drive cycle.

If the sensing condition is satisfied, then the actuator is controlled to move a driven element to a lens-uncovered position, as illustrated at block 54. Referring by way of example to the driven element 20′ illustrated in FIG. 4, the lens-uncovered position corresponds to a lens area 44 being generally in register with an aperture 46 through the body of the second magnetic field generator 36′. Control then proceeds to operation 56. Likewise, if the sensing condition is not satisfied, then control proceeds to operation 56.

A determination is made of whether a wiping condition is satisfied, as illustrated at operation 56. The wiping condition may include, for example, moisture or debris being detected, or a user selection such as activation of a windshield wiper.

If the wiping condition is satisfied, then the actuator is controlled to rotate the driven element through at least a partial rotation, as illustrated at block 58, to thereby clear debris or fluid from the lens. In an exemplary embodiment, the actuator starts and ends the rotation in corresponding positions, e.g. starting and ending in the lens-uncovered position. Control then proceeds to operation 60. Likewise, if the wiping condition is not satisfied, then control proceeds to operation 60.

A determination is made of whether a lens-covering condition is satisfied, as illustrated at operation 60. The lens-covering condition may include, for example, a drive cycle being terminated, or a sensing request from a controller being terminated.

If the lens-covering condition is satisfied, then the actuator is controlled to move a driven element to a lens-covered position, as illustrated at block 62. Referring by way of example to the driven element 20′ illustrated in FIG. 4, the lens-uncovered position corresponds to a lens area 44 being covered by the body of the second magnetic field generator 36′, i.e. not in register with any aperture 46. Control then returns to operation 52. Likewise, if the sensing condition is not satisfied, then control proceeds to operation 52.

As may be seen, the method illustrated in FIG. 5 thereby provides for cleaning and protection of a lens when desired, as well as enabling the lens to be uncovered when sensing is required. When used in conjunction with a driven element as illustrated in FIG. 4, a low-profile lens cleaning solution may thereby be provided.

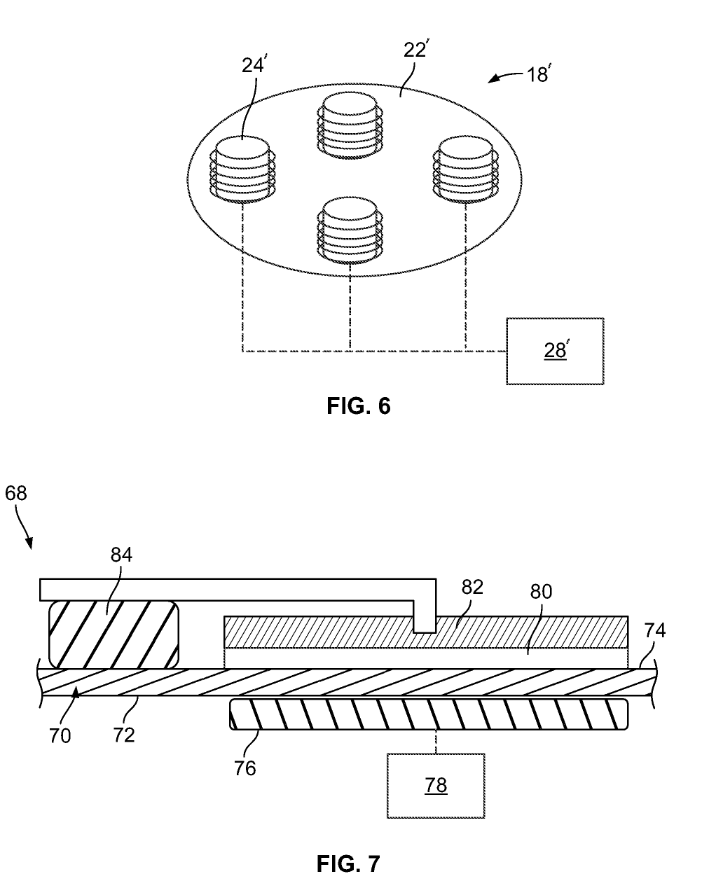

Referring now to FIG. 6, an alternative embodiment of a driver element 18′ is illustrated. The driver element 18′ includes a first magnetic field generator 22′ with a generally disk-shaped body provided with a plurality of electromagnetic coils 24′. The plurality of electromagnetic coils 24′ are under the control of a controller 28′. The controller 28′ is programmed to sequentially energize and de-energize the electromagnetic coils 24′ to generate a rotating magnetic field. The driver element 18′ may thereby function as a stator, with a driven element, such as those illustrated in FIG. 1 or 4, functioning as a rotor driven by the rotating magnetic field.

Referring now to FIG. 7, an alternative embodiment of an actuator assembly 68 according to the present disclosure is illustrated.

A panel 70 has a first surface 72 and a second surface 74. In an exemplary embodiment, the panel 70 includes a pane of window glass, the first surface 72 is an interior surface of the pane of window glass, and the second surface 74 is an exterior surface of the pane of window glass.

The actuator assembly 68 includes an inductive power transmitter coil 76 under control of a controller 78, an inductive power receiver coil 80, and a motor 82. The transmitter coil 76 is coupled to the first surface 72, and the receiver coil 80 is coupled to the second surface 74. The transmitter coil 76 and receiver coil 80 are thereby physically separated from one another by the panel 70. The controller is configured to control the transmitter coil 76 to create a magnetic field which induces an electric current in the receiver coil 80. The receiver coil 80 is electrically coupled to the motor 82 and thereby provides power to the motor 82 when the transmitter coil 76 is active. The motor 82 is coupled to a wiper member 84. The wiper member 84 is configured to sweep across the second surface 74 in a generally similar fashion as discussed above with respect to FIG. 1.

While the above has been discussed primarily with respect to wiper systems for window glass, alternative embodiments may be used to indirectly actuate other members in other types of systems. As an example, an actuator assembly having a driver element and driven element according to the present disclosure may be used to actuate a louver in an HVAC system, with the driver element being coupled to the exterior of a duct panel and the driven element being coupled to the interior of the duct panel and to a louver.

As may be seen, the present disclosure provides an actuator assembly for indirectly driving a wiper or other similar rotatable component without necessitating a hole through an intervening panel. Moreover, actuator assemblies according to the present disclosure may provide compact wiper assemblies relative to known solutions.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An actuator assembly comprising:
a driver element having a first magnetic field generator configured to generate a rotating magnetic field;
a driven element having a second magnetic field generator disposed thereon;
a panel disposed between the driver element and the driven element, the panel physically separating the driver element and the driven element, such that in response to the rotating magnetic field, the driven element is rotated relative to the panel.

2. The actuator assembly of claim 1, wherein the driven element is provided with a wiper member, the wiper member being fixedly coupled to the driven element for co-rotation relative to the panel.

3. The actuator assembly of claim 2, wherein the driven element has a body, the wiper member being disposed between the body and the panel.

4. The actuator assembly of claim 3, wherein the body has a periphery, at least one aperture being provided around the periphery.

5. The actuator assembly of claim 4, further comprising a sensor having a lens, the lens being in register with the panel, wherein the driven element has a first position and a second position, wherein in the first position the aperture is aligned with the lens to uncover the lens and in the second position the body covers the lens.

6. The actuator assembly of claim 5, further comprising a controller configured to, in response to a first operating condition being satisfied, control the driver element to move the driven element to the first position, and, in response to a second operating condition being satisfied, control the driver element to move the driven element to the second position.

7. The actuator assembly of claim 6, further comprising an automotive vehicle, wherein the first operating condition includes a drive cycle being initiated and the second operating condition includes a drive cycle being terminated.

8. The actuator assembly of claim 1, further comprising a housing mounted to the panel, the driven element being rotatably retained by the housing.

9. The actuator assembly of claim 1, wherein the driver element includes an electric motor having an output shaft, the output shaft being coupled to a driver body provided with a plurality of permanent magnets.

10. The actuator assembly of claim 9, wherein the driven element includes a driven body provided with a second plurality of permanent magnets.

11. The actuator assembly of claim 1, wherein the driver element includes a plurality of electromagnets arranged circumferentially about the driver element and a controller configured to sequentially energize respective electromagnets of the plurality of electromagnets to generate the rotating magnetic field.

12. An automotive vehicle comprising:
a panel having a first side and a second side;
a driver element disposed proximate the first side, the driver element having a first magnetic field generator;
a driven element disposed proximate the second side, the driven element having a second magnetic field generator disposed thereon, wherein the driven element is physically separated from the driver element by the panel; and
a controller configured to control the driver element to generate a rotating magnet field, wherein in response to the rotating magnetic field, the driven element is rotated relative to the panel.

13. The automotive vehicle of claim 12, wherein the driven element is provided with a wiper member, the wiper member being fixedly coupled to the driven element for co-rotation relative to the panel.

14. The automotive vehicle of claim 13, wherein the driven element has a body, the wiper member being disposed between the body and the panel.

15. The automotive vehicle of claim 14, wherein the body has a periphery, at least one aperture being provided around the periphery.

16. The automotive vehicle of claim 15, further comprising a sensor having a lens, the lens being in register with the panel, wherein the driven element has a first position and a second position, wherein in the first position the aperture is aligned with the lens to uncover the lens and in the second position the body covers the lens, wherein the controller is configured to, in response to a first operating condition being satisfied, control the driver element to move the driven element to the first position, and, in response to a second operating condition being satisfied, control the driver element to move the driven element to the second position.

17. The automotive vehicle of claim 16, wherein the first operating condition includes a drive cycle being initiated and the second operating condition includes a drive cycle being terminated.

18. The automotive vehicle of claim 12, wherein the driver element includes an electric motor having an output shaft, the output shaft being coupled to a driver body provided with a plurality of permanent magnets.

19. The automotive vehicle of claim 18, wherein the driven element includes a driven body provided with a second plurality of permanent magnets.

20. A method of controlling a vehicle, comprising:
providing the vehicle with a panel having a first side and a second side, a driver element with a first magnetic field generator disposed proximate the first side, a driven element with a second magnetic field generator disposed proximate the second side, the driven element being physically separated from the driver element by the panel, the driven element having distinct first and second positions with respect to the panel, and a controller configured to control the driver element;
in response to a first operating condition, controlling the driver element, via the controller, to generate a rotating magnet field to move the driven element to the first position; and
in response to a second operating condition, controlling the driver element, via the controller, to generate a rotating magnet field to move the driven element to the second position.
